(19) United States
(12) Patent Application Publication
(10) Pub. No.: US 2006/0031302 A1
(43) Pub. Date: Feb. 9, 2006

(54) Method, system and server for sending and receiving e-mails with different addresses

(75) Inventor: Olli Nuortila, Espoo (FI)

Correspondence Address: YOUNG & THOMPSON, 745 SOUTH 23RD STREET, 2ND FLOOR, ARLINGTON, VA, 22202, US

(73) Assignee: EMIDEX OY, ESPOO (FI)

(21) Appl. No.: 10/628,225

(22) Filed: Jul. 29, 2003

Related U.S. Application Data
(63) Continuation of application No. PCT/FI02/00078, filed on Feb. 1, 2002.

(30) Foreign Application Priority Data
Feb. 1, 2001 (FI) 20010194

(51) Int. Cl. G06F 15/16

(52) U.S. Cl. 709/206

(57) ABSTRACT

The method makes possible to keep particular e-mails separate from other e-mails and is based upon an interaction between a plug-in program in the user's e-mail client program and a separate mediating server. User's private address and e-mail service address are saved in the mediating server. E-mail client program is programmed to send all private messages to the mediating server. When a message is sent the plug-in program removes the original user given recipient address on the recipient field temporarily to another field, and replaces it with the address of the mediating server. To the user the message appears to have been sent to the original recipient. The mediating server receives the messages, replaces the sender's address with the sender's private address in the mediating server, restores the original recipient address(es), from the other field of the message, to the recipient field(s) and sends the message to the original recipient(s).

### CROSS REFERENCE TO RELATED APPLICATION

This application is the 35 USC 120 continuation of international application PCT/FI02/00078 filed on Feb. 1, 2002, which designated the United States of America.

### FIELD OF THE INVENTION

The present invention generally relates to separation of e-mail communication with an e-mail address from e-mail communication with other e-mail address in an e-mail client program. Especially the invention relates to separation of private e-mail communication from work related e-mail communication.

### BACKGROUND ART

Electronic mail (e-mail) has become an important means of communication between organizations and private persons. E-mail is widely used for carrying out work related tasks as well as for private communication. The number of employees having access to the Internet at work place is increasing rapidly and many employees have a personal e-mail address in the employer's address domain. The most widely used address format in the Internet is: firstname.familyname@organization.suffix, where the suffix may be a country code, commercial organization code (com or net), a public organization code (org), or a combination thereof.

From an employer's point of view an employee's personal office e-mail address in the employers' address domain is intended solely for carrying out work related tasks. However, employees often use their personal office e-mail address also for private communication. Personal office e-mail addresses are used for e-mail communication as well as for communication at various discussion forums in the Internet. Using the same e-mail address for both private communication and work related tasks is causing problems. Rights and obligations concerning the employees' private e-mail messages in the employer's e-mail system (whether sent from or received to such system) are still unclear. On the one hand, employees' private e-mails may get privacy protection that is similar to that of letter correspondence, whereupon employers would have no rights in any circumstances to read such private e-mails. On the other hand, it has been stated that since the employer provides an employee with a personal e-mail address and access to the employer's e-mail system solely carrying out work related tasks the employee may not assume privacy of such e-mail correspondence and the employer is free to read all messages saved in his e-mail system.

Hence, a problem is how to put into practice the privacy protection of the employees' private e-mail messages in the employer's e-mail system. Since private and work related messages sent from as well as received to a particular employee's personal e-mail address are in the same folders, it is usually impossible to make distinction between the private and the work related messages without opening the message. One cannot conclude with any certainty from the subject-field or from the sender or receiver information of an e-mail message whether the message is a private message or a work related message. It may also be impossible to know whether a message sent by an employee from his personal office e-mail address is meant to be a private message or a message sent for and on behalf of the employer.

In addition to the privacy protection of employees' private e-mail messages, there are a number of other reasons why it would be helpful to be able to keep certain e-mail correspondence in an office e-mail system separate from other more general e-mail correspondence. For example, the amount of e-mails today in some work environments is excessive and may make it difficult for the recipient to find the messages requiring more or different kind of attention than the bulk of the messages. Certain correspondence may require exceptional confidentiality or one may want to keep correspondence in different functions or responsibilities separate from each other.

### SUMMARY OF THE INVENTION

An objective of the present invention is to provide a method for keeping particular e-mail messages sent from or received to an e-mail client program in an e-mail system separate from other messages in the same e-mail system; e.g._for keeping employees' private e-mail messages separate from the work related messages.

The invention is based upon interaction between an e-mail client program in the user's desktop computer and a server computer (“private-address-server”) in the Internet. Hereafter said server computer is called “mediating server”. User's private e-mail address and personal office e-mail address are saved in the mediating server. The client program is programmed to send all messages that are marked private to the mediating server, by replacing the receiver's address, which is removed to another field of the message, with the address of the mediating server. To the user the message seems to be sent to the actual receiver. The mediating server receives the message, replaces the sender's address with the user's private e-mail address, restores the original receiver's address from the other field to the receiver field and sends the message further to the original recipient(s). To the recipient(s) the message appears to have been sent from the sender's private e-mail address.

The user of the method directs all private e-mail to be sent to him to his private e-mail address. When the mediating server receives a message addressed to a user it marks the message private and reroutes it further to an e-mail address or addresses assigned by the user from time to time (typically the user's personal office e-mail address).

The user's e-mail client program has been set to transfer all private messages, i.e. all messages from the mediating server, or sent through it (or otherwise marked as private) to a separate private e-mail folder, in order to keep them separate from the user's work related e-mail messages.

The method makes it possible to keep separate from each other the e-mail messages “owned” by the employee and those “owned” by the employer in the employer's e-mail system, and in so doing removes the risk of unintentional violation of privacy of the employee's private e-mail messages. The method is so easy to use that the employers can reasonably expect the employees to use it. No modifications are required to the employer's e-mail server or to any commercial e-mail servers. The employee may continue to use his private e-mail address even if he is taking a job with another employer, or when he is retiring. The user does not have to change his private e-mail address even if he is starting to use the services of another commercial e-mail service provider.

As the method may be used for receiving or sending messages under another e-mail address than the address assigned in the relevant e-mail service, and for keeping such messages separate from e-mail messages sent or received under the e-mail system address, it is possible for a user of the invented method to sort automatically personal e-mail correspondence by using different addresses for different category of e-mails in one e-mail client program.

### BRIEF DESCRIPTION OF THE DRAWINGS

The invention is described in more detail in the accompanying drawings in which:

FIG. 1 illustrates a system based on the invention; and

FIG. 2 is a flowchart of private message transmission

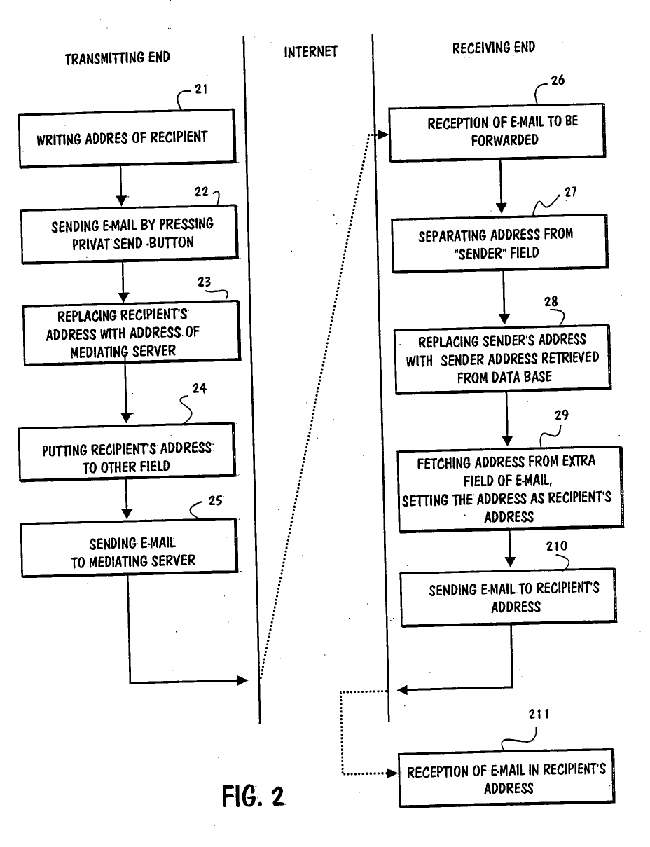

### DETAILED DESCRIPTION OF THE INVENTION

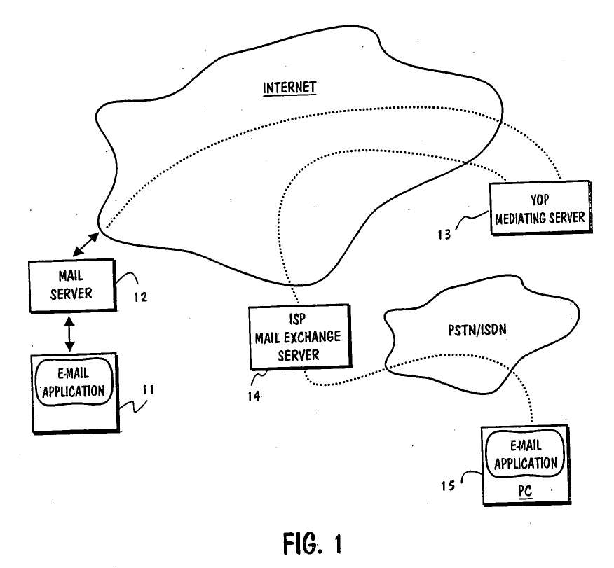

FIG. 1 shows the necessary elements for the realization of the method. In this example an employee has access to the Internet through desktop computer 11 and employer's e-mail server 12. The server is continuously connected to the Internet and e-mails are routed to the recipient immediately. Another user, employee or private person, has access to the Internet through PSTN or ISDN connection by dialing the telephone number to an internet service provider 14. The internet service provider saves e-mails addressed to the recipient's account to the internet service provider's e-mail server's hard disk, and e-mails can be read by taking a dial-up connection to the internet service provider. These two methods dedicated line and dial-up connection are the most common ways of using e-mail.

The elements to be added to the existing systems described above in the invented method are a plug-in extension to the user's e-mail client program and a relay server connected to the Internet 13 (mediating server). A plug-in function has been added to the e-mail client program of the user's desktop computer 11 to carry out the address changes in accordance with the invention. In the address change the recipient's address (or recipients' addresses) is replaced with the address of the mediating server 13 and the address, or addresses, originally placed in the recipient field(s) is/are placed to another field(s) of the e-mail message. Such other field(s) may be any field(s) other than address field, which complies with the relevant internet message standards. There may be more than one recipient address fields; the main recipient address field (TO:), the first additional recipient address field (CC:) and the second additional recipient address field (BCC:). To each recipient address field one can place one or more e-mail addresses. Address changes are described in more detail hereinafter. The client program add-on functions are run automatically. When a user chooses to send private message he/she only has to elect to press a new push button (“send private mail”), created to the relevant e-mail client program by the plug-in program, instead of the ordinary send-buttons It is also possible to make a program extension which detects if the user selects the recipient's address from a private address list and asks the user to confirm that the message shall be sent as a private message. In practice it will be feasible to create a separate private message form, the selection of which automatically runs the address chance for routing the message to the mediating server.

The private message is transmitted quite normally through the employer's e-mail server 12 to the Internet where it finds its way to its target address, i.e. the mediating server 13, hereafter as the YOP-server. This server transmits the message onwards after is has YOP-server remove its own address from the recipient field and replaces it with the original recipient address(es), placed to the recipient field(s) by the user, which original address(es) the server now fetches from the other field(s). In addition to that, before sending the message onwards, YOP-server replaces the sender's address with the employee's e-mail address in the YOP-server domain.

Thus, the recipient shall not see that the message was originally sent from the employee's office address. To the recipient the message appears to be sent from the employee's YOP-server address.

The method is described in more detail in Drawing 2. Let's assume that a company has a domain address ‘company.com’ and an employee of the company has an office e-mail address: myname@company.com. The employee wants to communicate privately with a person whose name is Bertta. The private e-mail address of Bertta is: bertta@isp-provider.com. The employee's private e-mail address in YOP-server is: myname@YOP.net. When sending private e-mail from his desktop computer 11 the employee writes or places to the recipient field of his e-mail client program quite normally bertta@isp-provider.com., phase 21. To the sender field of the message the e-mail client program adds automatically the employee's e-mail address: myname@company.com. The sender and recipient fields of the message are as set forth in table 1.

TABLE 1

| | |
|---|---|
| Recipient: (TO:) | Bertta@isp-provider.com |
| Sender: (FROM:) | myname@company.com |

Instead of the pressing now the ordinary send-button the employee presses the button created by the plug-in program, phase 22. The button may be market as “private send”, “send as private” or in any other clearly distinctive manner. Such button can be easily added e.g. to Microsoft Outlook™ e-mail program with Microsoft Visual Basic® programming language.

As a response to the pressing of the button the plug-in program replaces the receiver's address in the message's receiver field with YOP-server's address, phase 23. Further, the plug-in program creates to the message an additional field, to which field it inserts the original recipient's address, phase 24. The new field must be in accordance with the applicable internet standard in order not to cause any problems in the intermediately e-mail servers. Other alternative would be to add the original recipient address to the message field, or to any other field where it doesn't effect the transmission of the message. The fields of the message modified by the plug-in program would be now as set forth in table 2.

TABLE 2

| | |
|---|---|
| Recipient: (TO:) | YOP@YOP.net |
| Sender: (FROM:) | myname@company.com |
| Additional field: | Bertta@isp-provider.com |

Thereafter the message is transmitted in an ordinary way and it is routed to YOP-server, phase 25. Finally the plug-in program may automatically move the message to the user's private folder, if this feature is chosen. All phases 23-25 take place automatically.

The message is now transmitted to its target address, i.e. YOP-server receives the message, phase 26. YOP-server 13, Drawing 1, has in its database a two-way description from the user's office e-mail address to the user's private e-mail address which is maintained in the YOP-server. In this example the description is myname@company.com<->myname@YOP.net. YOP-server now verifies from the sender field the work e-mail address of the sender, phase 27 and looks from the database the private e-mail address which the user has chosen for his private e-mail correspondence, phase 28. For this purpose one can use e.g. properly configured SendMail program. YOP-server replaces the employee's office address in the sender field (FROM:) with his private e-mail address found from the database.

Simultaneously YOP-server restores the original recipient address, removed by the plug-in program to an additional field, to the recipient field, phase 29. This e-mail address, or addresses, was originally placed by the employee in his e-mail client program to the recipient field. Thereafter YOP-server re-transmits the message to its target address(es), phase 210. The address fields of the message are now as set forth in table 3.

TABLE 3

| | |
|---|---|
| Recipient: (TO:) | Bertta@isp-provider.com |
| Sender: (FROM:) | myname@YOP.net |

As one can see from the above table when the recipient receives the message he sees it to be sent from the sender's private address at YOP-server.

In the following the sequence of events is explained when a private e-mail message is sent to the employee. When the recipient replies to the employee's private message, or otherwise sends a private e-mail message to the employee, he places employee's private address, maintained in YOP-server to the recipient field and his own e-mail address to the sender field. When applying the addresses in the above example the address fields of the message are as shown in table 4.

TABLE 4

| | |
|---|---|
| Recipient: (TO:) | myname@YOP.net |
| Sender: (FROM:) | Bertta@isp-provider.com |

The message is received by YOP-server. By comparing the recipient address to its database YOP-server identifies that the recipient is a user of the invented method in YOP-server. YOP-server then looks for the recipient's corresponding office e-mail address in its database (or any other e-mail address or addresses which the user may have been given to YOP-server from time to time), and replaces the address in the recipient field (TO:) with this e-mail address. The address of the sender is then removed to an additional (or another) field. The address of YOP-server is automatically placed to the sender (FROM:) field when the message is retransmitted to the recipient(s). The address fields of the message are now as set forth in table 5.

TABLE 5

| | |
|---|---|
| Recipient: (TO:) | myname@company.com |
| Sender: (FROM:) | YOP@YOP.net |
| Additional field: | Bertta@isp-provider.com |

Thereafter YOP-server sends the e-mail to the address set fort in the above table and the e-mail is routed to the employee's desktop computer e-mail client program. The plug-in program in the employee's e-mail client program verifies the sender addresses and when the sender is YOP-server the program fetches the address of the original sender from the additional (or other) field of the e-mail message and places it to the sender (FROM:) field in replace of the YOP-server address. Thus the address fields shown to the user are as set forth in table 6. Thereafter the program may remove the message to a separate private mail folder if so desired.

TABLE 6

| | |
|---|---|
| Recipient: (TO:) | myname@company.com |
| Sender: (FROM:) | Bertta@isp-provider.com |

For an example Microsoft Office™ programming provides running of certain program event when new mail is received.

The described method makes possible to receive e-mail messages to different e-mail addresses within one e-mail system and with one e-mail client program and to keep such messages sent to different addresses separate from each other. Further the method makes possible to send e-mails with different sender addresses within one e-mail system and with one e-mail client program and to keep messages sent with different sender addresses separate from each other. The method makes also possible to send e-mails with one sender address from different e-mail servers.

In the above a variation of the method has been described in which the choice of a message being private is not made until at the actual moment of sending the message, i.e. when the ‘send private mail’-button is pressed. It is also possible to have separate writing form for private messages. In this case a new button or choice (“new private mail”) is made to the e-mail client program in addition to the existing (“new mail”) button or choice. In this case YOP-server address could be placed automatically in the recipient field of the message and the recipient address(es) placed to the recipient field of the writing form could be placed to another suitable field of the message.

The invented method is simple to realize. Yet it is very effective and easy to use. With the assistance of a small plug-in program the office e-mail client program can be used for sending and receiving safely also private e-mails. All private e-mails sent and received can be automatically encrypted when in transit between the plug-in program and YOP-server. The risk of an unintentional violation of privacy of e-mail correspondence can be removed. Employee's private YOP-address is independent from the employer. There is no need to change the private e-mail address even if one takes a job with another employer, if the name of the employer changes or when the employee is retired. All one has to do is to update the user's office e-mail address or other address where he acquires e-mail service in the YOP-server database. Since no changes are required to the e-mail protocols private YOP-address is independent from the e-mail service used from time to time.

To the employer the invented method provides unlimited access to all work related e-mail correspondence at his disposal. The employer can also deliberate himself from restoring employees' private e-mail correspondence in his e-mail servers. Private mail may be saved in a separate password protected file e.g. in the employee's desktop computer. By safeguarding the privacy of employees' private e-mail correspondence the method reduces the risk of any unnecessary tension, conflict or legal proceedings that may be caused by such violation. The use of the method does not require any investments to machinery or software to be made by the employer.

The method can be applied for sending and/or receiving e-mails with different e-mail addresses to/from one e-mail client program in one e-mail system and for keeping such e-mails separate from other e-mal correspondence also for other purposes than for keeping private e-mails separate from work related e-mails as explained hereinabove. E.g. one may want to keep e-mail correspondence relating to certain responsibility, task, matter or work project separate form other e-mail correspondence. With the invented method one can easily open a separate e-mail address for e-mail correspondence relating to a particular responsibility, task, matter or project and keep all such correspondence separate from other e-mail correspondence.

The method can also be applied for sending and receiving e-mails under one e-mail address (collective e-mail address) with more than one e-mail client programs. Changes to the use of such collective e-mail address saved in the private address server can be easily carried out over the Internet.

1. A method for keeping user's particular outgoing e-mail correspondence separate from user's other e-mail correspondence, characterized by the steps of:
in the user's e-mail client program
replacing in a particular outgoing e-mail message a recipient address set by the user with the address of a mediating server,
moving the recipient address into another field of the e-mail message,
sending the e-mail message to the mediating server,
and in the mediating server
moving in the e-mail message to be forwarded the recipient address from said another field into the recipient field, and
placing the address used in said particular e-mail correspondence into the sender field of the e-mail message.

2. The method as in claim 1, characterized in that
the recipient address is put into the recipient field of the message,
additional information is added to the recipient address in the recipient field which causes the recipient address to be ignored when the message is routed to the mediating server.

3. The method as in claim 1, characterized in that
when the user places a plurality of recipient addresses to the message all the recipient addresses are replaced with the address of the mediating server,
all the recipient addresses placed to the message by the user are moved into other field or fields of the message than any of the recipient fields.

4. The method as in claim 1, characterized in that replacing and moving of the address are carried out automatically in response to the pressing by the user of a particular send button.

5. The as in claim 1, characterized in that replacing and moving of the address are made automatically by means of a particular message writing form that contains the address of the mediating server not visible to the user.

6. A method for keeping user's incoming particular e-mail correspondence separate from user's other e-mail correspondence, characterized by the steps of:
routing an e-mail mail addressed to the user's particular e-mail address is to a mediating server,
moving in the mediating server the original sender address into other field than the address field,
replacing the address in the recipient field with another address specified by the user,
placing the address of the mediating server into the sender field, and
retransmitting the e-mail to the address specified by the user.

7. The method as in claim 6, characterized in that
an identifier is added to a message retransmitted from the mediating server,
a message received by the user's e-mail client program is identified to be a particular message on the bases of the identifier.

8. The method as in claim 6, characterized in that, in the user's e-mail client program,
the original e-mail address of the sender is moved from said other field into the sender field of the received e-mail message.

9. The method as in claim 6, characterized in that when the user is one of the recipients of the e-mail message sent from the original sender address:
in the mediating server, the addresses of the other recipients of the message to be sent further from the mediating server are replaced to other field than the address field of the message,
in the user's e-mail client program, the addresses of the other recipients are extracted from said other field and shown to the user.

10. A system for keeping user's particular e-mail correspondence separate from user's other e-mail correspondence, comprising:
an e-mail client program in the user's computer for sending and receiving e-mails,
a mediating server that retransmits e-mail messages received from the user to the message's recipient address and e-mail messages sent to the user to the user's e-mail address
characterized in that the mediating server comprises:
a database containing the user's e-mail address in the e-mail service that he is using and the user's address in the mediating server,
means for replacing the sender address of the message received from the user with the user's address in the mediating server, and for replacing the mediating server's address in the recipient address field with the address or addresses of the original recipient(s) temporarily placed in another field or fields than address field of the message.
means for replacing the user's mediating server address in the receiver field of the message received to the user's mediating server address with the user's address in the e-mail service that he is using and for moving the sender address of the received message into another field of a message to be retransmitted,
and that a plug-in program has been added to the e-mail client program, said plug-in program bein adapted to:
replace, in a message to be sent from the client program, the receiver's address placed in the recipient address field of the message by the user with the address of the mediating server,
move, in a message to be sent from the client program, the receiver's address placed in the recipient address field of the message by the user into other field of the message than an address field, and
replace, the in the message received to the client program, the original sender address placed in said other field than the address field to the sender field of the message.

11. An e-mail mediating server in a computer network e.g. in the Internet, characterized in that the mediating server comprises:
a database containing users' e-mail address in the e-mail service that they are using and the users' e-mail address in the mediating server,
means for replacing the sender address of a message received from a user with the user's e-mail address in the mediating server and for replacing the address of the mediating server in the receiver address field with the address of the receiver, or that of the receivers placed in another field of the message than an address field,
means for replacing the user's mediating server address in the recipient field of a message received to the mediating server with the user's e-mail address in the e-mail service he is using and for placing the sender address of the message received to the mediating server to another field of the message than an address field in the message to be retransmitted.

12. The e-mail mediating server as in claim 11, characterized in that it further comprises means for placing the other recipient addresses of a message received to the user's mediating server address to another field of the message to be retransmitted than to an address field so that the user's e-mail client program can then extract these other addresses and show them to the recipient.
